(19) United States
(12) Patent Application Publication
(10) Pub. No.: US 2003/0158327 A1
(43) Pub. Date: Aug. 21, 2003

(54) Polyurethane coating compositions

(76) Inventors: Qiwen Han, East Brunswick, NJ (US); Paul Ling-Kong Hung, Watchung, NJ (US)

Correspondence Address: JOHN DANIEL WOOD, RHODIA INC., CN-7500, 259 PROSPECT PLAINS RD., CRANBURY, NJ, 08512, US

(21) Appl. No.: 10/348,080

(22) Filed: Jan. 21, 2003

Related U.S. Application Data
(60) Provisional application No. 60/351,286, filed on Jan. 23, 2002.

(51) Int. Cl. C08K 3/00

(52) U.S. Cl. 524/589

(57) ABSTRACT

A coating composition containing a polyisocyanate compound having an isocyanate functionality of greater than 1, a polyol compound having an average hydroxyl functionality of greater than 1, wherein the relative amounts of polyisocyanate compound and polyol compound are in an amount effective to provide from 0.5 to 1.5 equivalents of isocyanate groups per equivalent of hydroxyl groups, from 0.0002 to 5 parts by weight of an organometallic curing catalyst selected from organobismuth, organozirconium or organoaluminum curing catalysts per 100 parts by weight of the polyisocyanate compound and from 0.0001 to 2.5 parts by weight of a moisture scavenger per 100 parts by weight of the polyisocyanate compound exhibits improved resistance to surface imperfections due to the phenomenon of “solvent popping”.

### CROSS-REFERENCE TO RELATED APPLICATIONS

This application claims priority from U.S. application Ser. No. 60/351,286, filed Jan. 23, 2002, the disclosure of which is incorporated herein by reference.

### TECHNICAL FIELD

The present invention is directed to polyurethane coating compositions, more specifically to polyurethane coating compositions that offer improved resistance to surface imperfections.

### BACKGROUND

Two-component thermosetting polyurethane compositions are widely used in protective coatings or films in a broad range of applications such as for example, coatings for automotive, trucks, aircraft, bridges, boats and other surfaces in need of protection from weathering, chemical and corrosion attack. These room temperature-curable polyurethanes are prepared from polyisocyanates.

Two-component polyurethane coating systems include a polyisocyanate component that reacts with a polyol resin, such as an acrylic or polyester polyol to form useful films. Such systems typically contain a curing catalyst, pigments and a solvent and may contain a variety of adjuvant components, e.g. surface active agent, dispersants, diluents, air release agents and fillers. This type of coating is very useful for large objects on which it is difficult to apply coatings and on which a coating cannot be heat cured, such as large machinery, storage tanks, bridges and aircraft.

Under certain conditions, two-component polyurethane coating systems are susceptible to an undesirable phenomenon know as “solvent popping”, wherein surface defects, such as bubbles, pinholes and craters, form during curing of the coating. Solvent popping typically occurs when the two-component polyurethane is applied in hot and humid conditions such as, for example, at temperatures above 80° F. (27° C.) and relative humidity above 65%, although the phenomenon may occur at lower temperature and lower humidity in some polyurethane systems. In any case, the severity of the problem increases as the temperature and/or humidity rises.

What is needed is to find a way to minimize surface defects in two-component polyurethane coatings, particularly in those cases wherein the coating must be applied and cured under hot and humid conditions.

### SUMMARY OF THE INVENTION

In a first aspect, the present invention is directed to a liquid coating composition, comprising:

a polyisocyanate compound having an isocyanate functionality of greater than 1,

a polyol compound having an average hydroxyl functionality of greater than 1,

wherein the relative amounts of polyisocyanate compound and polyol compound are in an amount effective to provide from 0.5 to 1.5 equivalents of isocyanate groups per equivalent of hydroxyl groups,

from about 0.0002 to about 5 parts by weight (“pbw”) of an organometallic curing catalyst selected from the group consisting of organobismuth curing catalysts, organozirconium curing catalysts, organoaluminum curing catalysts and mixtures thereof per 100 pbw of the polyisocyanate compound, and

from about 0.0001 to about 5 pbw of a moisture scavenger per 100 pbw of the polyisocyanate compound.

In a second aspect, the present invention is directed to a curing accelerator system for use in a liquid crosslinkable coating that contains a polyurethane compound and a polyol compound, said curing accelerator system comprising a moisture scavenger and an organometallic curing catalyst selected from the group consisting of organobismuth curing catalysts, organozirconium curing catalysts, organoaluminum curing catalysts and mixtures thereof.

In a third aspect, the present invention is directed to a method for accelerating the cure of a liquid crosslinkable coating composition, said composition containing a polyurethane compound and a polyol compound, while minimizing surface defects in the cured coating composition, comprising adding to the liquid coating composition from about 0.0002 to about 5 pbw of an organometallic curing catalyst selected from the group consisting of organobismuth curing catalysts, organozirconium curing catalysts, organoaluminum curing catalysts and mixtures thereof.

### DETAILED DESCRIPTION OF THE INVENTION

In a preferred embodiment the relative amounts of polyisocyanate compound and polyol compound in the coating composition of the present invention are effective to provide from 0.95 to 1.05 equivalents of isocyanate groups per equivalent of hydroxyl groups, and the coating composition of the present invention comprises from 0.005 to 5 pbw of the curing catalyst per 100 pbw of the polyisocyanate compound, and from 0.005 to 2.5 pbw of the moisture scavenger per 100 pbw of the polyisocyanate compound.

As used herein, the terminology “isocyanate functionality” means the number of isocyanate (—NCO) groups per molecule and the terminology “hydroxyl functionality” means the number of hydroxyl (—OH) groups per molecule.

In a preferred embodiment, the polyisocyanate compound of the present invention is a polyisocyanate oligomer having an isocyanate functionality of from greater than 2 to about 6 NCO groups per molecule of polyisocyanate oligomer.

In a preferred embodiment, the polyisocyanate oligomer has a number average molecular weight, measured by gel permeation chromatography relative to polystyrene, of from about 500 to about 5,000 more preferably from about 600 to about 1,000.

In a preferred embodiment, the polyisocyanate oligomer comprises a product of a condensation reaction of isocyanate monomers. Suitable isocyanate monomers include, for example, 1,6-hexamethylene diisocyanate, 1,12-dodecane diisocyanate, cyclobutane-1,3-diisocyante, cyclohexane-1,3-diisocyanate, cyclohexane-1,4-diisocyanate, 1-isocyanato-3,3,5-trimethyl-5-diisocyanatomethylcyclohexane and mixtures thereof. In a preferred embodiment, the polyisocyanate compound comprises hexamethylene diisocyanate trimer.

As used herein, the terminology “hydroxyl number” means the amount of hydroxyl groups per unit weight of sample and is expressed in milligrams KOH per gram of sample (mg KOH/g). In a preferred embodiment, the polyol has a hydroxyl number of from about 50 to about 200, more preferably from about 100 to about 175.

The number average molecular weight of the polyol is measured by gel permeation chromatography using a polystyrene standard. In a preferred embodiment, the polyol has a number average molecular weight of from about 500 to about 80,000.

Suitable polyol compounds are known in the art and include, for example, polyether polyols, polyester polyols, polyacrylate polyols and mixtures thereof.

Suitable polyether polyols include, for example, ethoxylation or propoxylation products of water or diols.

Suitable polyester polyols are, for example, made by known polycondensation reaction of one or more acid or corresponding anhydride with one or more polyhydic alcohol. Suitable acids for example, benzoic acid, maleic acid, adipic acid, phthalic acid, isophthalic acid, terephthalic acid and sebacic acid as well as their corresponding anhydrides, and dimeric fatty acids and trimeric fatty acids and short oils. Suitable polyhydic alcohols include, for example, ethylene glycol, 1,4-butanediol, 1,6-hexane diol, neopentyl glycol, tetraethylene glycol, polycarbonate diols, trimethylolpropane and glycerol.

In a highly preferred embodiment, the polyol comprises a polyacrylate polyol. Suitable acrylic polyols are made, for example, by known copolymerization reactions of one or more hydroxyalkyl(meth)acrylate monomers, such as, for example, hydroxy(C₁-C₈)alkyl (meth)acrylates, with one or more acrylate monomers, such as, for example, (C₁-C₁₀)alkyl acrylates and cyclo(C₆-C₁₂)alkyl acrylates, or with one or more methacrylate monomers, such as, for example, (C₁-C₁₀)alkyl methacrylates, and cyclo(C₆-C₁₂)alkyl methacrylates, or with one or more vinyl monomer, such as, for example, styrene, α-methylstyrene, vinyl acetate, vinyl versatate, or with a mixture of two or more of such monomers. Suitable hydroxyalkyl(meth)acrylate monomers include for example, hydroxyethyl acrylate, hydroxypropyl acrylate, hydroxyethyl methacrylate, hydroxypropyl methacrylate. Suitable alkyl (meth)acrylate monomers include, for example, methyl methacrylate, ethyl methacrylate, butyl methacrylate, butyl acrylate, ethylhexyl methacrylate, isobornyl methacrylate. Suitable polyacrylate polyols include, for example, hydroxy(C₂-C₈)alkyl (meth)acrylate- co-(C₂-C₈)alkyl (meth)acrylate copolymers.

The coating composition of the present invention may, optionally, further comprise one or more solvents. Such solvents may be added to the composition separately or may be added to the composition as a mixture with the polyisocyanate oligomer, the polyol or with both the polyisocyanate oligomer and the polyol. Suitable solvents include aromatic solvents, such as, for example, xylene, toluene and aliphatic solvents, such as, for example, n-butyl acetate, t-butyl acetate, acetone, as well as mixtures of such solvents, such as, for example, Aromatic 100 (a mixture of aromatic solvents, available from ExxonMobil).

Suitable organobismuth, organozirconium or organoaluminum curing catalysts are commercially available and include, for example, a bismuth carboxylate known as K-Kat 348 catalyst, a zirconium chelate known as K-Kat XC-4205 catalyst, an aluminum chelate known as K-Kat XC-5218 catalyst, a zirconium complex known as K-Kat XC-6212 catalyst and a zirconium complex known as K-Kat XC-9213 catalyst, each available from King Industries, Norwalk, Conn.

Suitable moisture scavengers are known in the art and include, for example, para-toluene sulfonyl isocyanate, oxazolidines, orthoformates, orthoacetates, and alkyl esters of toluene sulfonic acid, such as methyl para-toluene sulfonic acid.

The composition of the present invention may, optionally, also include minor amounts of additives known in the coatings art, such as, for example, flow aids, flatting agents, defoamers, leveling aids, surfactants UV absorbers and pigments. In a preferred embodiment, the coating composition of the present invention is a clear, that is, non-pigmented, coating.

The composition of the present invention is made by combining and the components in the relative amounts described above and mixing the components to obtain a substantially homogeneous mixture.

The composition of the present invention is applied to a substrate, which may be any solid material, preferably to a metal substrate, by known application techniques, such as, for example, spraying, draw down bar, spinning, brushing, dipping or roller.

The curing or cross-linking of the coating composition can take place after application to a substrate at temperatures of from 0° C. to 200° C. (32° F. to 392° F.). In a preferred embodiment, the coating composition of the present invention is cured at a temperature of from about 20° C. (68° F.) to about 60° C. (140° F.), more preferably from about 30° C. (86° F.) to about 50° C. (122° F.). In a preferred embodiment, the coating is then allowed to post-cure at ambient conditions for at least 3 days.

### EXAMPLES 1-12

The following components were used in Examples 1-12:

| | |
|---|---|
| Part A | polyisocyanate compound (Jet Glo Part A (Fast Red BASE) |
| | CM0820061, Sherwin-Williams) |
| Part B | polyester urethane compound (Jet Glo Part B (Hardener) |
| | CM0820081, Sherwin-Williams) |
| SW-Cat | dibutyl tin dilaurate catalyst (Jet Glo Part C (18 Hour |
| | Activator) CM0820H18, Sherwin-Williams) |
| T-9 | dibutyl tin dilaurate catalyst (DABCO T-9, Air Products) |
| KK4205 | organozirconium catalyst (K-Kat 4205, Air Products) |
| KK6212 | organozirconium catalyst (K-Kat XC-6212, Air Products) |
| KK9213 | organozirconium catalyst (K-Kat XC-9213, Air Products) |
| KK348 | organobismuth catalyst (K-Kat 348, Air Products) |
| KK5218 | organoaluminum catalyst (K-Kat 5218, Air Products) |
| 2,4-PD | 2,4-Petanedione (Dow) |
| MAK | Methyl n-amyl ketone (Eastman) |
| BEA | 2-Butoxyethyl acetate (Aldrich) |
| ODDA | Oxo-dodecyl acetate (ExxonMobil) |
| pTSI | p-toluene sulfonyl isocyanate (van de Mark Group) |
| Incozol 2 | oxazolane additive (Industrial Copolymers) |
| TMFO | trimethyl orthoformate (Creanova) |
| MTS | methyl para-toluene sulfonate (Aldrich) |

A solvent mixture was prepared according to Table 1.

TABLE 1
Solvent Mixture for Part C

| Part C | | | | | |
|---|---|---|---|---|---|
| Solvent | Total (g) | 2,4-PD (g) | MAK (g) | BEA (g) | ODDA (g) |
| Ratio | 100 | 24 | 33 | 33 | 10 |
| Amount | 1243.7 | 298.5 | 410.4 | 410.4 | 124.4 |

Catalysts were diluted with the solvent mixture to form Parts C1-C5, as set forth in Table 2.

TABLE 2
Part C Catalyst Compositions

| Part C | Catalyst | Cat Wt (g) | Solvent (g) | Cat content (%) |
|---|---|---|---|---|
| C1 | SW Cat | 60 | 0 | 0.13 |
| C2 | KK4205 | 0.8775 | 67.50 | 1.3 |
| C3 | KK6212 | 0.8308 | 63.91 | 1.3 |
| C4 | KK9213 | 0.1231 | 61.54 | 0.2 |
| C5 | KK348 | 0.0794 | 61.07 | 0.13 |

The coating compositions of Examples 1-12 were each made by first combining Part A and Part B with Part C and Part D according to Table 1 below in a paint can, as follows:

(a) in the coating compositions of Examples 1,2 3, 4, 5, Parts A (75.0 g), B (75.0 g) and C (2.27 g) were each charged to a paint can,

(b) in the coating composition of Example 6, Parts A (75.0 g) and B (75.0 g) were each charged to a paint can, then solvent mixture (2.24 g) was charged to the paint can and finally K-Kat 5218 (0.03 g) was charged to the paint can,

(c) in the coating compositions of Examples 7, 8, 9 and 10 Parts A (75.0 g), B (75.0 g), C (2.27 g) and D (3.75 g) were each charged to a paint can, and

(d) in the coating composition of Examples 11 and 12, Parts A (75.0 g) and B (75.0 g) and D (3.75 g) were each charged to a paint can, then the solvent mixture (2.24 g) was charged to the paint can and finally K-Kat 5218 (0.03 g) was charged to the paint can.

TABLE 3
Parts C and D of Coating Compositions and Blistering Results

| | | | Blistering |
|---|---|---|---|
| Ex # | Part C | Part D | Results |
| 1 | C1 | — | 6 |
| 2 | C2 | — | 3 |
| 3 | C3 | — | 5 |
| 4 | C4 | — | 4 |
| 5 | C5 | — | 3 |
| 6 | C6 | — | 2 |
| 7 | C1 | pTSI | 6 |
| 8 | C5 | Icozol 2 | 1 |
| 9 | C5 | TMOF | 3 |
| 10 | C5 | MTS | 1 |
| 11 | C6 | Incozol 2 | 1 |
| 12 | C6 | MTS | 2 |

In each case, the paint can containing the components of the coating composition was then sealed and shaken for 3 minutes in paint can shaker (Red Devil). The contents of the paint can were allowed to sit undisturbed for 30 minutes and then used to spray coat Al panels (with chromate pre-treatment, AL412, Q-Panel).

The coated panels were placed in a temperature/humidity chamber at 95±5° F. at a relative humidity of from 65 to 75% for 45 minutes. A second coat of the coating mixture was applied to each of the panels. The coated panels were then placed in the temperature/humidity chamber at 95±5° F. at a relative humidity of from 65 to 75% for 24 hours.

The panels were then visually inspected for evidence of bubble formation and ranked on a scale from 1 (no evidence of bubbling) to 6 pronounced bubbling). Results are set forth above in Table 3.

The coating composition cured using an organobismuth, organozirconium or organoaluminum curing catalyst showed improved resistance to bubble formation, particularly in those cases wherein the coating composition also contained a moisture scavenger.

What is claimed is:

1. A liquid coating composition, comprising:
(a) a polyisocyanate compound having an isocyanate functionality of greater than 1,
(b) a polyol compound having an average hydroxyl functionality of greater than 1, wherein the relative amounts of polyisocyanate compound and polyol compound are in an amount effective to provide from 0.5 to 1.5 equivalents of isocyanate groups per equivalent of hydroxyl groups,
(c) from about 0.0002 to about 5 parts by weight (“pbw”) of an organometallic curing catalyst selected from the group consisting of organobismuth curing catalysts, organozirconium curing catalysts, organoaluminum curing catalysts and mixtures thereof per 100 pbw of the polyisocyanate compound, and
(d) from about 0.0001 to about 5 pbw of a moisture scavenger per 100 pbw of the polyisocyanate compound.

2. A composition as claimed in claim 1 wherein the relative amounts of polyisocyanate compound and polyol compound in the coating composition of the present invention are effective to provide from about 0.95 to about 1.05 equivalents of isocyanate groups per equivalent of hydroxyl groups.

3. A composition as claimed in claim 1 wherein the curing catalyst comprises from about 0.005 to about 5 pbw per 100 pbw of the polyisocyanate compound.

4. A composition as claimed in claim 1 wherein the moisture scavenger comprises from about 0.005 to about 2.5 pbw per 100 pbw of the polyisocyanate compound.

5. A composition as claimed in claim 1 wherein the polyisocyanate compound is a polyisocyanate oligomer having an isocyanate functionality of from greater than 2 to about 6 NCO groups per molecule of polyisocyanate oligomer.

6. A composition as claimed in claim 5 wherein the polyisocyanate oligomer has a number average molecular weight of from about 500 to about 5,000.

7. A composition as claimed in claim 5 wherein the polyisocyanate oligomer has a number average molecular weight of from about 600 to about 1,000.

8. A composition as claimed in claim 5 wherein the polyisocyanate oligomer comprises a product of a condensation reaction consisting essentially of isocyanate monomers.

9. A composition as claimed in claim 8 wherein the isocyanate monomers are selected from the group consisting of 1,6-hexamethylene diisocyanate, 1,12-dodecane diisocyanate, cyclobutane-1,3-diisocyante, cyclohexane-1,3-diisocyanate, cyclohexane-1,4-diisocyanate, 1-isocyanato-3,3,5-trimethyl-5-diisocyanatomethylcyclohexane and mixtures thereof.

10. A composition as claimed in claim 1 wherein the polyisocyanate compound comprises hexamethylene diisocyanate trimer.

11. A composition as claimed in claim 1 wherein the polyol compound is selected from the group consisting of polyester polyols and polyacrylate polyols.

12. A composition as claimed in claim 1 wherein the curing catalysts are selected from the group consisting of bismuth carboxylates, zirconium chelates, aluminum chelates, and zirconium complexes.

13. A composition as claimed in claim 1 wherein the moisture scavengers are selected from the group consisting of para-toluene sulfonyl isocyanate, oxazolidines, orthoformates, orthoacetates, and alkyl esters of toluene sulfonic acid.

14. A liquid coating composition, comprising:
(a) a polyisocyanate oligomer having an isocyanate functionality of greater than 1,
(b) a polyol compound having an average hydroxyl functionality of greater than 1, wherein the relative amounts of polyisocyanate compound and polyol compound are in an amount effective to provide from about 0.95 to about 1.05 equivalents of isocyanate groups per equivalent of hydroxyl groups,
(c) from about 0.005 to about 5 parts by weight (“pbw”) of an organometallic curing catalyst selected from the group consisting of organobismuth curing catalysts, organozirconium curing catalysts, organoaluminum curing catalysts and mixtures thereof per 100 pbw of the polyisocyanate compound, and
(d) from about 0.005 to about 2.5 pbw of a moisture scavenger per 100 pbw of the polyisocyanate compound.

15. A curing accelerator system for use in a liquid crosslinkable coating that contains a polyurethane compound and a polyol compound, said curing accelerator system comprising a moisture scavenger and an organometallic curing catalyst selected from the group consisting of organobismuth curing catalysts, organozirconium curing catalysts, organoaluminum curing catalysts and mixtures thereof.

16. A method for accelerating the cure of a liquid crosslinkable coating composition, said composition containing a polyurethane compound and a polyol compound, while minimizing surface defects in the cured coating composition, comprising adding to the liquid coating composition from about 0.0002 to about 5 pbw of an organometallic curing catalyst selected from the group consisting of organobismuth curing catalysts, organozirconium curing catalysts, organoaluminum curing catalysts and mixtures thereof.
